(19) United States
(12) Patent Application Publication
(10) Pub. No.: US 2013/0226740 A1
(43) Pub. Date: Aug. 29, 2013

(54) PRODUCT DELIVERY AUGMENTED WITH ACCOMPANYING VIDEO

(71) Applicant: Sharlon A. Biliosa, Willemstad (NL)

(72) Inventor: Sharlon A. Biliosa, Willemstad (NL)

(21) Appl. No.: 13/777,950

(22) Filed: Feb. 26, 2013

Related U.S. Application Data
(60) Provisional application No. 61/604,259, filed on Feb. 28, 2012.

(51) Int. Cl. G06Q 30/06

(52) U.S. Cl. CPC G06Q 30/0633
USPC 705/26.82; 705/26.1; 705/26.8

(57) ABSTRACT

A method, system and computer program product for providing product delivery in conjunction with a communications network. The method comprises processing, over the communications network, the purchase of a product by a buyer for delivery to a recipient, receiving, over the communications network, a content generated by the buyer for delivery to a recipient, storing the content in association with a unique identifier, transmitting purchase information of the product, and the unique identifier, to an entity local to the recipient, wherein the entity effectuates delivery of the product and the unique identifier to the recipient and providing the content on the communications network in response to entry of the unique identifier.

### CROSS-REFERENCE TO RELATED APPLICATIONS

This application claims the benefit under 35 U.S.C. §119(e) of U.S. Provisional Patent Application Ser. No. 61/604,259 filed on Feb. 28, 2012, which is hereby incorporated herein by reference in its entirety.

### TECHNICAL FIELD

The present invention relates to the field of e-commerce, and more particularly to the field of video-augmented product delivery facilitated by a communications network.

### BACKGROUND OF THE INVENTION

Every day, millions of tangible consumer products, from consumer appliances to flowers, are delivered to recipients. The product delivery experience, however, has not changed in several decades. A conventional product delivery process typically comprises a user interacting with a vendor online or on the telephone to purchase a product, often using a credit card or debit card. Once the sale has been effectuated, the vendor fulfills the order by requesting the product from inventory or from a manufacturer and having it mailed, couriered or otherwise delivered in person to the address of the recipient. Once the product has been delivered to the recipient at a home or business address, the conventional product delivery process is complete.

One of the drawbacks of the conventional product delivery process is that it is immensely impersonal, since it comprises a usually unknown person making the delivery to the recipient. This is a disadvantage when the product being delivered is a gift, such as flowers, from the buyer (or “sender”) to the recipient. Another drawback of the conventional product delivery process is that it does not leverage the myriad of advanced technologies that are available today. With the advent of the Internet, the World Wide Web, widely available broadband connections and cellular communications networks, there is a need and desire to augment the conventional product delivery process with more contemporary technologies.

Therefore, what is needed is a system, method and computer program product for improving the problems with the prior art, and more particularly for a method and system that augments conventional product delivery using a communications network.

### SUMMARY OF THE INVENTION

Embodiments of the present invention address deficiencies of the art in respect to e-commerce and provide a novel and non-obvious method, system and computer program product for providing product delivery in conjunction with a communications network.

In a first aspect, the present invention provides a method for delivering product ordered by a sender for delivery to a recipient, in conjunction with a communications network. The product seller receives a product order from a sender and receives digital content, such as a video, (also referred to herein as “content” or “video”) authorized by the sender for delivery to a recipient. The seller stores the content in association with an identifier that identifies the content sufficiently so that the content may be provided later upon entry of the identifier. The seller transmits information comprising product order information and the identifier to an entity to so that the entity may effectuate delivery of the product and/or identifier to the recipient. The seller then provides the content over the communications network in response to entry of information comprising the identifier.

Different embodiments of the first aspect may comprise various steps and limitations. The content may comprise any digital content type, such as a video, an audio message, a static image such as a photo or drawing or other graphic, animation, text, music, or any combination of content types. The seller may process over the communications network the sender's purchase of the product. The entity may be local to the recipient and may be more local than the seller to the recipient. The content may have been generated by the sender and personalized to the sender, recipient, and/or their relationship. The identifier may be a unique identifier containing information unique to the storage location, content, metadata, tags or other aspect of the digital content. The seller may require entry of recipient identifying information, such as the recipient's name, address, telephone number, or any other identifying information (also referred to herein as “recipient information”), and may provide the video upon entry of such recipient information and/or the identifier.

The method may involve the seller's: receipt of a question and at least one secret answer from the sender, and storage of the content in association with the answer and the aforesaid identifier. In that case, the content may be provided upon receipt of an entry comprising the identifier and one or more of said secret answers. The seller may provide one or more questions that the sender may designate for delivery to recipient, and the sender may provide seller with the secret answers to the designated question or questions. Sender may provide more than one acceptable answer to any question. The seller would provide the entity with the identifier and questions. The method may also require the entry of a separate password, which is separate from the identifier, before the seller provides the video, which password may be provided to the recipient by the sender, seller or entity over the communications network, separately from product delivery, via email or any other suitable mode of electronic communication. The password may be provided by any process. In that case, the content may be stored in association with the identifier, answer, and password and the content may be provided upon entry of the identifier, answer and password.

In a second aspect, the present invention provides a method for video augmentation of product delivery, in conjunction with a communications network, comprising receiving an identifier and digital content authorized by a sender of product; storing the digital content in association with information comprising the identifier; and providing the digital content over the communications network in response to entry of information comprising the identifier.

Different embodiments of the second aspect may comprise various features. There may be a prior step of providing a seller of the product with the identifier. The sender may effectuate delivery of the product and identifier to the recipient. The method may comprise receiving a question and secret answer from the sender, wherein the storing step comprises storing the digital content in association with information comprising an identifier and the secret answer, and the providing step comprises providing the digital content over the communications network in response to entry of information comprising the identifier and secret answer.

In a third aspect, the present invention provides a method of accomplishing product delivery, in conjunction with a communications network, on behalf of a seller of product ordered by a sender for delivery to a recipient, comprising: receiving product order information and an identifier, wherein the identifier is associated with digital content authorized by the sender and stored on a server; and delivering the identifier and product to a recipient.

In a fourth aspect, the present invention provides a method of processing an order for a product, comprising: receiving, over a communications network, the order from a sender, and providing, over a communications network, the sender with access to a database for storing sender-authorized digital content in association with an identifier.

In a fifth aspect, the present invention provides a method of product delivery, comprising: providing a product to a sender; and providing an identifier that identifies sender-authorized electronic content stored on a server that is accessible over a communications network upon entry of the identifier. The sender-authorized electronic content may comprise content generated by the sender or content designated by the sender from content created by the product seller or a third party.

In a sixth aspect, the present invention provides a computer system for providing product delivery in conjunction with a communications network, said computer system comprising a memory and a processor in communications with the memory, wherein the computer system is capable of performing a method comprising: processing, over the communications network, purchase of product by a sender for delivery to a recipient; receiving, over the communications network, digital content authorized by the sender for delivery to the recipient; storing the digital content in association with an identifier; transmitting product purchase information and the identifier to an entity local to the recipient, wherein the entity effectuates delivery of the product and the identifier to the recipient; and providing the digital content over the communications network in response to entry of information comprising the identifier.

In a seventh aspect, the present invention provides a computer program product to facilitate providing product delivery in conjunction with a communications network, the computer program product comprising a storage medium readable by a data processing device and storing instructions for execution by the data processing device for performing a method comprising: processing, over the communications network, purchase of product by a sender for delivery to a recipient; receiving, over the communications network, digital content authorized by the sender for delivery to the recipient; storing the digital content in association with an identifier, transmitting product purchase information and the identifier to an entity local to the recipient, wherein the entity effectuates delivery of the product and the identifier to the recipient; and providing the digital content over the communications network in response to entry of information comprising the identifier.

Accordingly, it is an object of the present invention to add a personal touch to the delivery of gift packages.

It is another object of the present invention to enhance the marketing of online purchases.

It is yet another object of the present invention to provide better communication between the buyer of a product and its ultimate recipient.

It is a still further object of the present invention to enhance the presentation of an in person gift.

It is still another object of the present invention to provide a mechanism for a retailer to supplement and enhance the purchasing experience.

It is an even further object of the present invention to exploit the communication capabilities present in modern day communication devices such as smart phones, laptops, ultrabooks, tablets and the like.

These, and other features, advantages and aspects of this invention will become apparent from the following detailed description of the various aspects of the invention taken in conjunction with the accompanying drawings, and in part will be obvious from the description, or may be learned by practice of the invention. It is to be understood that both the foregoing general description and the following detailed description are exemplary and are not restrictive of the invention, as claimed. Additional aspects of the invention will be set forth in part in the description which follows, and in part will be obvious from the description, or may be learned by practice of the invention. The aspects of the invention will be realized and attained by means of the elements and combinations particularly pointed out in the appended claims.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for providing product delivery in conjunction with a communications network, in accordance with one embodiment of the present invention.

FIG. 2 is a block diagram illustrating a network architecture of a simplified system for providing product delivery in conjunction with a communications network, in accordance with one embodiment of the present invention.

FIG. 3 is a block flow diagram illustrating a method in accordance with the present invention.

FIG. 4 is a block flow diagram illustrating another method in accordance with the present invention.

FIG. 5 is an arrow flow diagram illustrating another method in accordance with the present invention.

FIG. 6 is an arrow flow diagram illustrating another method in accordance with the present invention.

FIG. 7 is a block flow diagram illustrating another method in accordance with the present invention.

### DETAILED DESCRIPTION

The present invention improves upon the problems with the prior art by providing a more effective and technologically advanced product delivery system provided over a communications network, such as the Internet. The present invention allows consumers to purchase products online and effectuate the delivery of those products to an intended recipient, along with a unique identifier for a personal content that may be accessed online by the recipient. This creates a more personal product delivery experience and leverages recent technological advances, so as to augment the conventional product delivery experience.

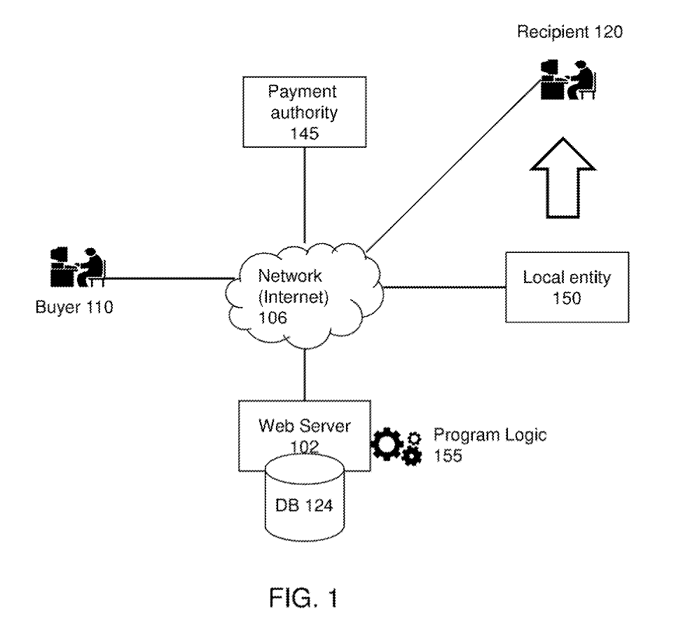

Referring now to the drawing figures in which like reference designators refer to like elements, there is shown in FIG. 1 an illustration of a block diagram showing the network architecture of a software application in accordance with the principles of the present invention. FIG. 1 shows an embodiment of the present invention wherein a buyer 110, comprising a user and a computer, interacts with web server 102 over a network 106, which can be a packet switched network such as the Internet or the World Wide Web. The buyer 110 can purchase products via the web server 102, upload a video, and have the product and video delivered to the recipient 120. Recipient 120 comprises a user and computer. The computers of users 110 and 120 may be a desktop, a laptop, handheld computer, a smart phone, a tablet computer or the like. Said computers may be equipped with a camera (also referred to herein as a webcam), which may be used by the user to make video and audio recordings.

Web server 102 includes a software engine that delivers applications, such as online e-commerce services, content delivery and other data to users 110, 120. It should be noted that although FIG. 1 shows only two users 110, 120 and one web server 102, the system of the present invention supports any number of client users and web servers connected via network 106. Server 102 includes program logic 155 comprising computer source code, scripting language code or interpreted language code that is compiled to produce computer instructions that perform various functions of the present invention.

FIG. 1 further shows that web server 102 is connected to a database 124, which may be used to store records, such as profiles, user account data, user purchase data, user credentials, identifiers, user questions and answers and contents which have been created and uploaded by users.

FIG. 1 also shows a payment authority 145 to effectuate payments by buyers 110 for the purchase of products, content delivery and product delivery services via server 102. In one embodiment of the present invention, the payment authority 145 is a payment gateway, which is an e-commerce Application Service Provider (ASP) service that authorizes payments for e-businesses, online retailers, or traditional brick and mortar businesses. A payment gateway is the equivalent of a physical point-of-sale terminal located in most retail outlets. Payment gateways encrypt sensitive information, such as credit card numbers, to ensure that information passes securely between the customer and the merchant. A payment gateway facilitates the transfer of information between a payment portal (such as a website) and the acquiring bank, quickly and securely. When a customer orders a product or service from a payment gateway enabled merchant, the payment gateway performs a variety of tasks to process the transaction. Payment gateways accept payment via the use of credit cards, charge cards, bank cards, gift cards, account cards, etc.

Lastly, FIG. 1 shows a local entity 150, which may comprise a local merchant, a local vendor and/or other delivery entity that is tasked with physically delivering a product and a content identifier, among other things, to the recipient 120.

Note that although server 102 is shown as a single and independent entity, in one embodiment of the present invention, the functions of server 102 may be integrated with the functions of another entity, such as entities 110, 120, 150, 145 of FIG. 1. Further server 102 and its functionality, according to a preferred embodiment of the present invention, can be realized in a centralized fashion in one computer system, or in a distributed fashion where different elements are spread across several interconnected computer systems.

The following will describe the control flow of the process for providing an augmented product delivery in conjunction with a communications network, in accordance with one embodiment of the present invention. First, the buyer 110 purchases one or more products online via the web server 102 and utilizing the payment services for payment authority 145. The product purchase process includes defining the products being purchased, entering electronic payment information and entering contact/delivery information for the buyer 110 and/or recipient 120. Subsequently, the buyer 110 may upload a content using his webcam to the server 102, which is stored in the database 124 in association with the product purchase information. The buyer 110 may also upload a secret question and answer to the server 102, which is stored in the database 124 in association with the product purchase information. Lastly, the server 102 generates a unique identifier or unique code that is associated with the content and the product purchase information.

Next, the server 102 transmits the product purchase information, the unique identifier and the secret question to the local entity 150 via the communications network 106. Finally, the local entity 150 fulfills the product order by physically delivering the purchased product to the recipient 120, along with the unique identifier and the secret question (which may be printed on a paper or plastic card). Subsequently, the recipient 120 may visit a web site of web server 102, enter the unique identifier, enter the answer to the secret question and access the content that corresponds to the unique identifier and the secret question. The recipient 120 may also prepare a content response and that may be transmitted over a communications network such as by email, text messaging, multimedia messaging, or otherwise to the buyer 110.

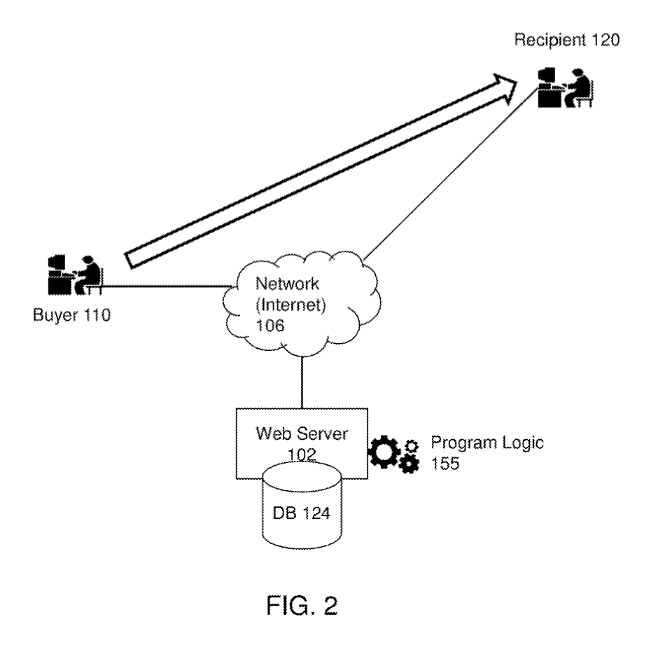

FIG. 2 is a block diagram illustrating a network architecture of a simplified system for providing product delivery in conjunction with a communications network, in accordance with one embodiment of the present invention. The following will describe the control flow of the process for providing an augmented product delivery in conjunction with a communications network, in accordance with FIG. 2. First, the buyer 110 purchases one or more products and a card with a unique identifier. Subsequently, the buyer 110 may upload a content using his webcam to the server 102, which is stored in the database 124 in association with the unique identifier. The buyer 110 may also upload a secret question and answer to the server 102, which is stored in the database 124 in association with the unique identifier.

Next, the buyer 110, or another entity, physically delivers the purchased product to the recipient 120, along with the unique identifier and the secret question (which may be printed on a paper or plastic card). Subsequently, the recipient 120 may visit a web site of web server 102, enter the unique identifier, enter the answer to the secret question and access the content that corresponds to the unique identifier and the secret question. The recipient 120 may also prepare a content response and that may be emailed to the buyer 110.

Entry of the identifier by the recipient may be by any suitable means, such as manual by using a computer key board, touch screen or the like, or by scanning, with a smart phone or any other device capable of scanning images, the identifier affixed to or otherwise delivered in conjunction with the product. Many smart phones on the market today are capable of scanning QR codes and other optical codes.

The content provided by the buyer may have different sources. The content may be generated personally by the buyer/sender, which provides means for providing a personalized message relating uniquely to the sender, recipient, their relationship, or common experiences. The content may also be selected from one or more prerecorded choices made available to sender by seller or by a third party. In any event, the content provided to the recipient is content that is or has been authorized by the buyer to be provided to the recipient.

Product may comprise goods, services or both. Product purchase information identifies the product that the sender wants delivered to the recipient, and may include any other information pertinent to the transaction, such as information pertaining to the sender, recipient, seller, local delivery entity, recipient address, purchase price, and delivery instructions. The identifier may be any indicia, name, symbol, device, sequence, code, bar code, QR Code, other machine readable optical code, or any other representation of data that may be used to identify, locate, access and/or retrieve the digital content to be delivered in the present invention.

The identifier may identify the location of the content in a database or other file system in which the content is or will be stored, and may identify file or data content, metadata, directory, file path, file name and other identifying information.

The identifier may be generated by the seller in association with the product sale, order, or other delivery request. Alternatively, the identifier may be issued in advance to the seller or seller's designee by a separate entity. The seller may provide the identifier to the sender or the product delivery entity for subsequent delivery to the recipient. The identifier may be provided in any fashion and may be printed on a card, label, or sticker that may be affixed to the product, product packaging or delivery wrapper or container.

The sender may upload one or more questions. The sender may upload more than one acceptable answer to any or all of the uploaded questions. In the alternative to, or in combination with, uploading a question and secret answer, the seller may provide one or more questions. The sender may designate one or more of the seller-provided questions and provide one or more answers to any or all of the designated questions. A question may comprise any inquiry that solicits or prompts a response. In a preferred embodiment, the question solicits an answer that is personal to the recipient, such as questions typically used as a security measure to verify an online user's identity before permitting access to an account. For example, the question may relate to date of birth, name of pet, name of relative, favorite color, or any other information that indicates that the user is the intended recipient. The question may related to sender's personal information known by recipient, such as the sender's favorite color, or may relate to something unique about the relationship between sender and recipient, such as where they first met.

Typically, in embodiments involving online purchases, the sender may be an online shopper using a computer and buying the product over a communications network. In some other aspects, the sender may be a buyer at a physical point of sale, such as a brick and mortar store.

While terms such as “buyer”, “purchaser”, “purchase” and “seller” used herein indicate that the method of the present invention may involve product purchase transactions, the present invention is not limited to purchase transactions. The terms “buyer”, “purchaser” and “sender” may be used interchangeably to identify a person or entity that initiates a product order or delivery request, regardless of whether a purchase transaction is involved. “Product purchase information” and “product order information” may be used interchangeably. The step of processing a purchase using a payment gateway is unnecessary where a purchase transaction is not involved. As used herein, the term “person” is not limited to a natural person, and may include any entity capable of performing the activity ascribed herein to a person, and the term “entity” is not exclusive of natural persons and may include any entity or person capable of performing the activity ascribed herein to an entity.

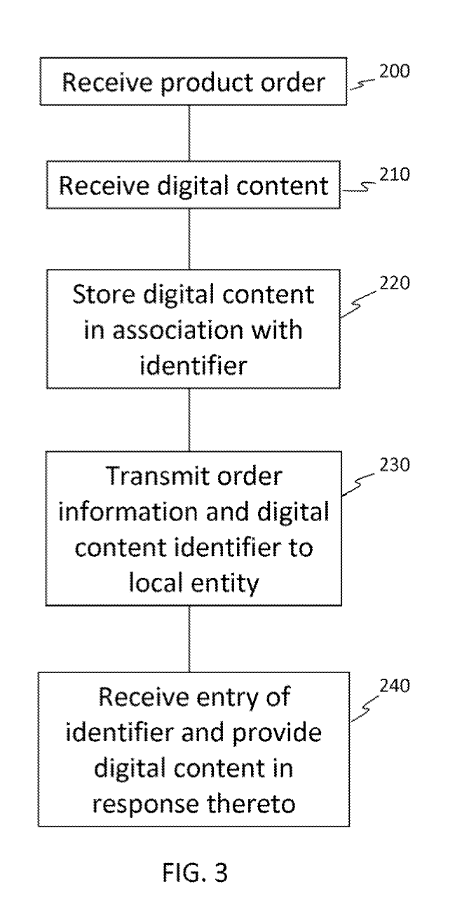

FIG. 3 shows a method in accordance with the present invention as carried out by an online seller, such as a national flower seller offering products over a telecommunications network. The seller receives an order, such as an order for flowers, from a buyer (also referred to as “sender” herein) in step 200 and receives digital content such as a personalized video from the sender in step 210. In step 220, the seller stores the video in a database or other file system on a server in association with an identifier that facilitates later location and retrieval of the video. In step 230, the seller transmits product order information and the identifier to an entity local to the intended recipient of the product, such as a local florist, so that the local entity can deliver the product and identifier to the recipient. In step 240, the seller provides the video to the recipient upon receipt of entry of the identifier. This improved method provides many advantages, such as allowing people to make more personalized and meaningful gift-giving.

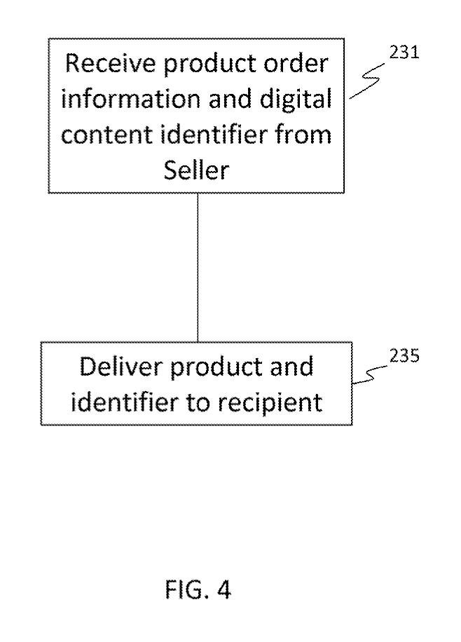

FIG. 4 shows a method in accordance with the present invention as carried out by the local entity referenced in FIG. 3. The local entity receives the product order information and identifier in step 231. The local entity then delivers the product and identifier to the recipient in step 235.

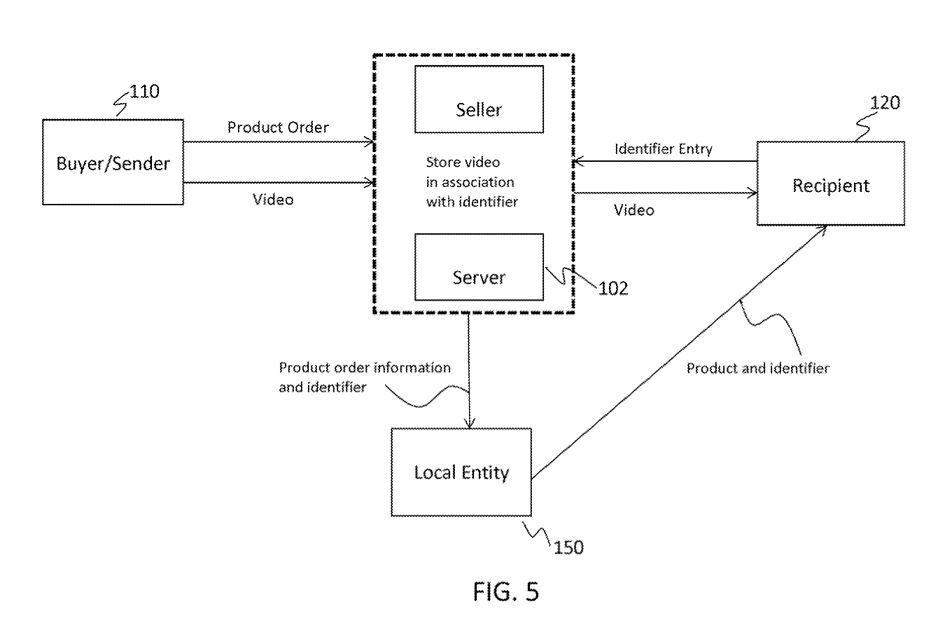

FIG. 5 provides another graphic representation of a method of the present invention, reference to which enhances ones understanding of the methods discussed hereinabove in reference to FIGS. 1 and 3. The seller, who controls a server 102 or has sufficient access and permission to use a server 102 controlled by someone else to conduct the methods herein, receives a product order from a buyer/sender 110 and receives a video from the buyer/sender, all over one or more communications networks. The seller stores the video in association with an identifier. The seller then provides the local entity 150 with the product order information and identifier so that the local entity can effectuate deliver of said items to the intended recipient 120. The seller then receives the recipient's entry of the identifier over a communications network and, in response thereto, provides the recipient with access to the video.

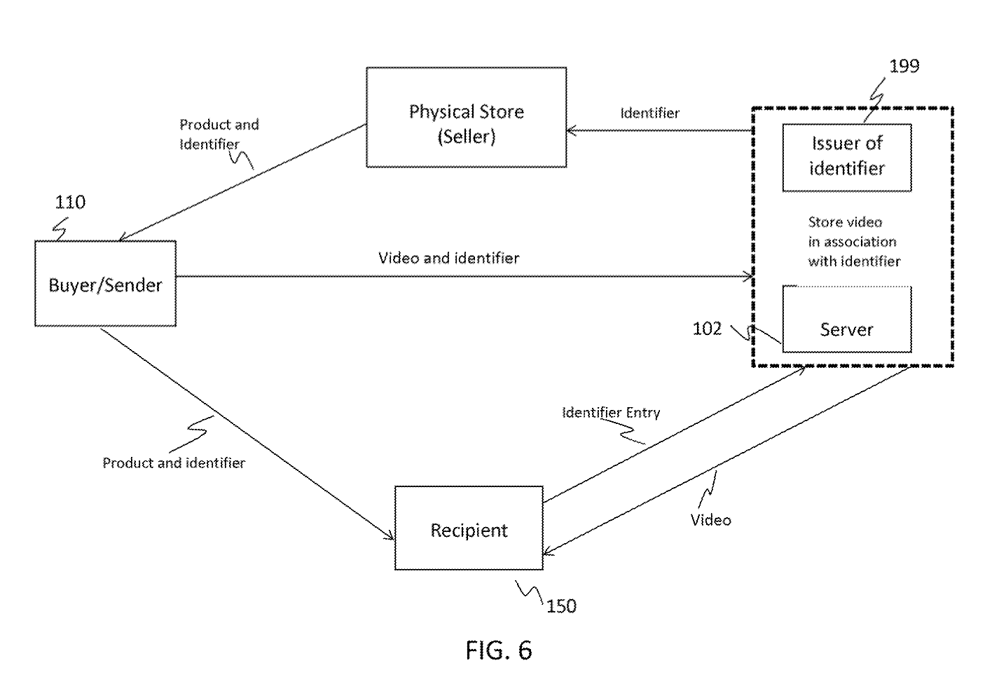

FIG. 6 provides another graphic representation of a method of the present invention, reference to which enhances ones understanding of the methods discussed hereinabove in reference to FIG. 2. An entity 199 (labeled the “issuer” in FIG. 6) that controls a server 102 or has sufficient access and permission to use a server 102 controlled by someone else to conduct the methods herein, issues identifiers and provides them to a seller that operates a physical store. The identifiers may be provided digitally or physically on preprinted cards, stickers, labels, packaging material or the like. When the seller conducts a sale, it provides the product and identifier to the buyer/sender 110. The issuer 199 receives a video upload from the buyer/sender 110 over a communications network onto the server 102 and stores the video on the server. The buyer/sender effectuates delivery of the product and identifier to the recipient 150. The issuer 199 then receives the recipient's entry of the identifier over a communications network and, in response thereto, provides the recipient with access to the video.

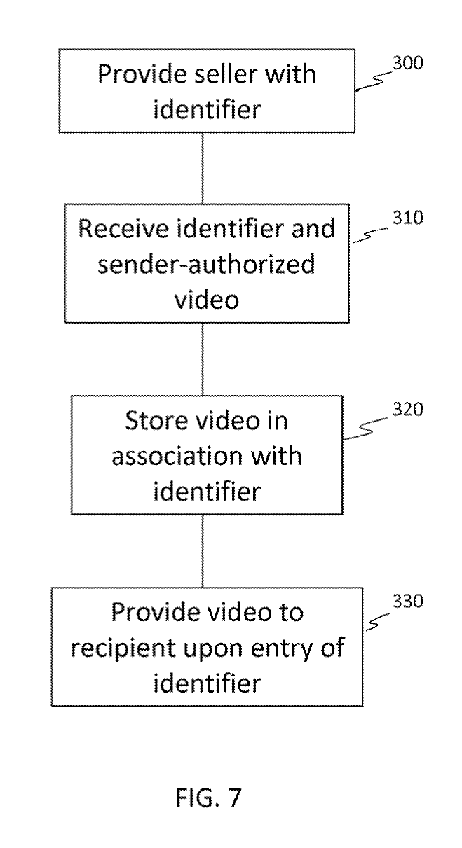

FIG. 7 provides another graphic representation of a method of the present invention discussed hereinabove in reference to FIGS. 1 and 3, but more particularly of the method carried out by the entity that controls a server 102 or has sufficient access and permission to use a server 102 controlled by someone else to conduct the methods herein. In step 300, which may be omitted in alternate embodiments, said entity provides the seller with identifiers. Then, after the seller conducts a sale, said entity receives in step 310 an identifier and a sender-authorized video over a communications network. In step 320, said entity stores the video on a storage medium on a server in association with the identifier. In step 330, said entity provides access to the video in response to receipt of entry of the identifier over a communications network.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems.

The capabilities of one or more aspects of the present invention can be implemented in software, firmware, hardware, or some combination thereof. At least one program storage device readable by a machine embodying at least one program of instructions executable by the machine to perform the capabilities of the present invention can be provided.

The process steps set forth herein are exemplary. There may be variations to these steps (or operations) described herein without departing from the spirit of the invention. For instance, some steps may be performed in a differing order, may be performed simultaneously, or steps may be added, deleted, or modified. All of these variations are considered a part of the claimed invention.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural and functional equivalents to the elements of the above-described preferred embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC §112, sixth paragraph, unless the element is expressly recited using the phrase “means for.”

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for providing delivery, in conjunction with a communications network, of product ordered by a sender for delivery to a recipient, comprising:
receiving a product order from a sender;
receiving digital content authorized by the sender for delivery to a recipient;
storing the digital content in association with information comprising an identifier;
transmitting information comprising product order information and the identifier to an entity; and
providing the digital content over the communications network in response to entry of information comprising the identifier.

2. The method of claim 1, wherein the digital content comprises at least one of video, audio, static image, graphics, animation, text and music.

3. The method of claim 1, further comprising:
processing, over the communications network, the purchase of the product by the sender for delivery to the recipient.

4. The method of claim 1, wherein the transmitting step comprises transmitting information comprising product order information and the identifier to an entity, wherein the entity effectuates delivery of the product and the identifier to the recipient.

5. The method of claim 1, wherein the entity is local to the recipient.

6. The method of claim 1 wherein the digital content authorized by the sender comprises digital content generated by the sender.

7. The method of claim 1, wherein the identifier comprises a unique identifier.

8. The method of claim 1, wherein the step of providing the digital content comprises providing the digital content in response to entry of information comprising recipient information and the identifier.

9. The method of claim 1, further comprising:
receiving a question and secret answer from the sender,
wherein the step of storing the digital content in association with information comprises storing the digital content in association with the identifier and the secret answer;
wherein the step of transmitting information comprises transmitting product order information, the identifier and the question to the entity; and
wherein the step of providing the digital content comprises providing the digital content over the communications network in response to entry of information comprising the identifier and secret answer.

10. The method of claim 1, further comprising:
providing at least one question to the sender,
receiving from the sender a designation of a question from said at least one question and a secret answer to the designated question;
wherein the storing step comprises storing the digital content in association with information comprising the identifier and the secret answer;
wherein the transmitting step comprises transmitting information comprising product order information, the identifier and the question to the entity; and
wherein the providing step comprises providing the digital content over the communications network in response to entry of information comprising the identifier and secret answer.

11. The method of claim 1, wherein:
the storing step comprises storing the digital content in association with information comprising the identifier and a separate password that is separate from the identifier; and
the providing step comprises providing the digital content over the communications network in response to entry of information comprising the identifier and password.

12. The method of claim 11, wherein the storing step comprises storing the digital content in association with information comprising the password, wherein the sender effectuates delivery of the password to the recipient.

13. A method for providing product delivery in conjunction with a communications network, comprising:
receiving an identifier and digital content authorized by a sender of product;
storing the digital content in association with information comprising the identifier; and
providing the digital content over the communications network in response to entry of information comprising the identifier.

14. The method of claim 13, further comprising:
a prior step of providing a seller of the product with the identifier.

15. The method of claim 13, wherein the receiving step comprises receiving an identifier and digital content authorized by a sender of product, wherein the sender effectuates delivery of the product and identifier to the recipient.

16. The method of claim 13, further comprising:
receiving a question and secret answer from the sender;
wherein the storing step comprises storing the digital content in association with information comprising an identifier and the secret answer;
wherein the providing step comprises providing the digital content over the communications network in response to entry of information comprising the identifier and secret answer.

17. A method of accomplishing product delivery, in conjunction with a communications network, on behalf of a seller of product ordered by a sender for delivery to a recipient, comprising:
receiving product order information and an identifier, wherein the identifier is associated with digital content authorized by the sender and stored on a server; and
delivering the identifier and product to a recipient.

18. A method of processing an order for a product, comprising:
receiving, over a communications network, the order from a sender;
providing, over a communications network, the sender with access to a database for storing sender-authorized digital content in association with an identifier.

19. A method of product delivery, comprising:
providing a product to a sender; and
providing an identifier that identifies sender-authorized electronic content stored on a server that is accessible over a communications network upon entry of the identifier.

20. A computer system for providing product delivery in conjunction with a communications network, said computer system comprising:
a memory; and
a processor in communications with the memory, wherein the computer system is capable of performing a method comprising:
processing, over the communications network, purchase of product by a sender for delivery to a recipient;
receiving, over the communications network, digital content authorized by the sender for delivery to the recipient;
storing the digital content in association with an identifier;
transmitting product purchase information and the identifier to an entity local to the recipient, wherein the entity effectuates delivery of the product and the identifier to the recipient; and
providing the digital content over the communications network in response to entry of information comprising the identifier.

21. A computer program product to facilitate providing product delivery in conjunction with a communications network, the computer program product comprising:
a storage medium readable by a data processing device and storing instructions for execution by the data processing device for performing a method comprising:
processing, over the communications network, purchase of product by a sender for delivery to a recipient;
receiving, over the communications network, digital content authorized by the sender for delivery to the recipient;
storing the digital content in association with an identifier;
transmitting product purchase information and the identifier to an entity local to the recipient, wherein the entity effectuates delivery of the product and the identifier to the recipient; and
providing the digital content over the communications network in response to entry of information comprising the identifier.
